(19) United States
(12) Patent Application Publication
(10) Pub. No.: US 2019/0191716 A1
(43) Pub. Date: Jun. 27, 2019

(54) MIXTURES OF SABADILLA ALKALOIDS AND PESTICIDES AND USES THEREOF

(71) Applicant: McLaughlin Gormley King Company, Golden Valley, MN (US)

(72) Inventor: Robert A. Suranyi, Minneapolis, MN (US)

(21) Appl. No.: 16/227,036

(22) Filed: Dec. 20, 2018

Related U.S. Application Data
(60) Provisional application No. 62/610,780, filed on Dec. 27, 2017.

(51) Int. Cl. A01N 65/40; A01N 43/90

(52) U.S. Cl. CPC A01N 65/40; A01N 43/90

(57) ABSTRACT

The present invention is directed to pesticidal mixtures comprising sabadilla alkaloids and at least one pesticide listed in paragraph [00012] of this application and methods of controlling pests including insects, mites, nematodes by application of pesticidal mixtures comprising sabadilla alkaloids and at pesticide.

### FIELD OF THE INVENTION

The present invention is directed to pesticidal mixtures comprising sabadilla alkaloids and at least one pesticide listed below in paragraph [00012] and methods of controlling pests by application of pesticidal mixtures comprising sabadilla alkaloids and at least one pesticide listed below in paragraph [00012].

### BACKGROUND OF THE INVENTION

Arthropod pests, nematode pests and fungal pests are major threats to human welfare and exert continued stress on the food supply and transmit a broad array of medical and veterinary diseases. Synthetic pesticides played a significant role and, in many ways, ushered in modern agriculture and pest control. However, the widespread use of synthetic pesticides also created numerous environmental challenges. The acute effects of synthetic pesticides on professional applicators and other end users are well-known but the chronic long-term human health effects can be equally serious. Further, the use of synthetic pesticides has led to the development of resistant pest populations. Pesticide resistance is a complex phenomenon underlined by a diverse array of physiological mechanisms. Major mechanisms that are responsible for the development of pesticide resistance are metabolic detoxification, target site mutation, reduced cuticular penetration and behavioral avoidance.

Integrated Pest Management (“IPM”) is a holistic approach to pest management. A fundamental aspect of insecticide utilization under the broader framework of IPM is the management of insecticide resistance (IRM) by the utilization of insecticide combinations that reduce the rate of resistance development. A combination of insecticides with different modes of action is fundamentally a concept based upon the idea of redundant killing of target insects. Insects adapted to one of the active ingredient in the combination product will still be killed by the other active ingredient. Mixtures can also reduce the amount of pesticides applied in the environment and the environmental impact associated with pesticide applications.

Most botanical pesticides are readily biodegradable and significantly less harmful to the environment and users than synthetic pesticides. The very short environmental persistence, usually less than 24 hours, of plant derived pesticides is favorable to the survival of non-target, beneficial parasites and predators which are important components of IPM. Unlike conventional pesticides which are typically based on a single active ingredient, plant derived pesticides usually comprise an array of chemical compounds that affect both behavioral and physiological functions of the target arthropods. The probability of pest resistance developing to plant derived pesticides is less than that for synthetic pesticides because these mixtures may have a variety of modes of action.

One effective naturally derived pesticide is found in the tissues of many of the plants of the genus Schoenocaulon, commonly referred to as sabadilla. The species with the longest history of use, and the most readily available, is Schoenocaulon officinale. The plant is indigenous to Central and South America and its seeds have been used for centuries for their insecticidal properties. The seeds contain several alkaloids including veratridine and cevadine, both of which are known to be active against arthropods.

Thus, there is a need in the art for pesticide combinations that contain naturally derived pesticides that decrease health concerns to humans and also decrease the risk of the development of pesticide resistance.

### SUMMARY OF THE INVENTION

In one aspect, the present invention is directed to pesticidal mixtures of sabadilla alkaloids and at least one pesticide listed below in paragraph [00012].

In another aspect, the present invention is directed to methods of controlling pests comprising applying an effective amount of a mixture of sabadilla alkaloids and at least one pesticide listed below in paragraph [00012].

In a preferred aspect, the sabadilla alkaloids are derived from Schoenocaulon officinale.

### DETAILED DESCRIPTION OF THE INVENTION

The present invention is directed to pesticidal mixtures comprising an effective amount of sabadilla alkaloids and at least one pesticide listed below in paragraph [00012].

Sabadilla alkaloids may be derived from any species of Schoenocaulon. The genus Schoenocaulon includes the following species: S. calcicola, S. caricifolium, S. comatum, S. conzattii, S. dubium (alt. S. gracile), S. framei, S. ghiesbreghtii (alt. S. drummondii, S. yucatanense), S. ignigenum, S. intermedium, S. jaliscense, S. macrocarpum (alt. S. lauricola), S. madidorum, S. megarrhizum, S. mortonii, S. oaxacense, S. obtusum, S. officinale, S. pellucidum, S. plumosum, S. pringlei, S. rzedowskii, S. tenorioi, S. tenue, S. tenuifolium, S. texanum, and S. tigrense. In a preferred embodiment the sabadilla alkaloids are derived from S. officinale. In another preferred embodiment the sabadilla alkaloids are veratridine and cevadine

Pesticides suitable for use in the present invention are limited to the following: acetylcholinesterase (“AChE”) inhibitors including but not limited to carbamates such as alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, xmc, xylylcarb and organophosphates such as acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-s-methyl, diazinon, dichlorvos/ddvp, dicrotophos, dimethoate, dimethylvinphos, disulfoton, epn, ethion, ethoprophos, famphur, fenamiphos, fenitrothion, fenthion, fosthiazate, heptenophos, isofenphos, isoxathion, malathion, mecarbam, methamidophos, methidathion, mevinphos, monocrotophos, naled, omethoate, oxydemeton-methyl, parathion, parathion-methyl, phenthoate, phosalone, phorate, phosmet, phosphamidon, phoxim, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion, pirimiphos-methyl, imicyafos, isopropyl o-(methoxyaminothio-phosphoryl) salicylate; gamma-amino butyric acid (“GABA”)-gated chloride channel blockers including but not limited to cyclodiene organochlorines such as chlordane and endosulfan; sodium channel modulators including, but not limited to, dichlorodiphenyltrichloroethane (“DDT”) and methoxychlor; nicotinic acetylcholine receptor (“nAChR”) competitive modulators including, but not limited to, butenolides such as flupyradifurone, zwitterionics such as dicloromezotiaz and triflumezopyrim, sulfoximines such as sulfoxaflor and nicotine; alkylhalides such as methyl bromide; fluorides such as cryolite and sulfuryl fluoride; borates such as borax, boric acid, disodium octaborate, sodium borate and sodium metaborate; methyl isothiocyanate generators such as dazomet and metam; chloropicrin; tartar emetic; chordotonal organ transient receptor potential (“TRP”) channel modulators including, but not limited to, pyridine azomethine derivatives such as pymetrozine; inhibitors of mitochondrial adenosine triphosphate (“ATP”) synthase including, but not limited to, organotin miticides such as azocyclotin, cyhexatin and fenbutatin oxide and diafenthiruon, propargite and tetradifon; uncouplers of oxidative phosphorylation via disruption of the proton gradient such as chlorfenapyr, dinitro-ortho-cresol (“DNOC”) and sulfuramide; nAChR channel blockers including, but not limited to, nereistoxin analogues such as bensultap, cartap hydrochloride, thiocyclam and thiosultap-sodium; octopamine receptor agonists such as amitraz; mitochondrial complex III electron transport inhibitors (“METI III”) such as acequinocyl, bifenazate and fluacrypyrim, hydramethylnon; mitochondrial complex I electron transport inhibitors (“METI I”) such as fenazaquin, pyrimidifen, pyridaben, tebufenpyrad and rotenone; voltage-dependent sodium channel blockers including, but not limited to, oxadiazines such as indoxacarb and semicarbazones such as metaflumizone; inhibitors of acetyl coenzyme (“CoA”) carboxylase including, but not limited to, tetronic and tetramic acid derivatives such as spirodiclofen and spiromesifen and spirotetramat; mitochondrial complex IV electron transport inhibitors (“METI IV”) including, but not limited to, phosphides such as aluminum phosphide, calcium phosphide, phosphine and zinc phosphide and cyanides such as calcium cyanide, potassium cyanide, sodium cyanide; mitochondrial complex II electron transport inhibitors (“METI II”) including, but not limited to, beta-ketonitrile derivatives such as cyenopyrafen and cyflumetofen and carboxanilides such as pyflubumide; isoxazolines such as afoxolaner, fluralaner, lotilaner and sarolaner; pyropenes such as afidopyropen; other compounds of an unclassified nature such as benzoximate; bromoproylate; chinomethionat; dicofol; GS-omega/kappa HXTX-HV1A peptide; lime sulfur; sulfur; acynonapyr; flometoquin; and spiroindoline.

As used herein, all numerical values relating to amounts, weight percentages and the like are defined as “about” or “approximately” each particular value, namely, plus or minus 10%. For example, the phrase “at least 5% by weight” is to be understood as “at least 4.5% to 5.5% by weight.” Therefore, amounts within 10% of the claimed values are encompassed by the scope of the claims.

The term “effective amount” means the amount of the formulation that will control the target pest. The “effective amount” will vary depending on the mixture concentration, the type of pest(s) being treated, the severity of the pest infestation, the result desired, and the life stage of the pest during treatment, among other factors. Thus, it is not always possible to specify an exact “effective amount.” However, an appropriate “effective amount” in any individual case may be determined by one of ordinary skill in the art.

In another preferred embodiment, the pesticidal mixtures of the present invention may contain one or more excipients selected from the group consisting of solvents, anti-caking agents, stabilizers, defoamers, slip agents, humectants, dispersants, wetting agents, thickening agents, emulsifiers, penetrants, adjuvants, synergists, polymers, propellants and/or preservatives.

The present invention is further directed to methods of controlling a pest comprising applying a pesticidal mixture comprising an effective amount of sabadilla alkaloids and at least one pesticide listed above in paragraph [00012] to the pest or the pest's environment.

In a preferred embodiment, the pest is selected from an insect, a mite, a nematode and a fungus.

In an embodiment, the pest controlled is selected from the group consisting of aphids (Homoptera), whiteflies (Hemiptera), thrips (Thysanoptera), bed bugs (Hemiptera), fleas (Siphonaptera), caterpillars/worms (Lepidoptera), beetles (Coleoptera), cockroaches (Blattodea), flies (Diptera), ants (Hymenoptera), mosquitoes (Culicidae), mites (Acari), leafhoppers (Cicadellidae), stink bugs (Pentatomidae), mealybugs (Pseudococcidae), ants (Formicidae), ticks (Ixodoidea) and stored product pests.

The pesticidal mixtures of the present invention can be applied by any convenient means. Those skilled in the art are familiar with the modes of application including spraying, brushing, soaking, in-furrow treatments, or side-dressing.

In a preferred embodiment, sabadilla alkaloids are applied to the pest or the pest's environment at a rate from about 1 to about 1,000 grams per hectare (“g/HA”), preferably from about 10 to about 700 g/HA and most preferably from about 11 to about 560 g/HA.

Application rates for the at least one pesticide listed above in paragraph [00012] can be derived from common knowledge by those skilled in the art. In a preferred embodiment, the at least one pesticide listed above in paragraph [00012] is applied to the pest or the pest's environment at a rate from about 1 to about 20,000 g/HA.

In another preferred embodiment, the pesticidal mixtures of the present invention comprise from about 0.05% to about 0.5% w/w sabadilla alkaloids.

Concentrations of the at least one pesticide listed above in paragraph [00012] can be derived from common knowledge by those skilled in the art. In a preferred embodiment, the pesticidal mixtures of the present invention comprise from about 0.001% to about 10% w/w of the at least one pesticide listed above in paragraph [00012]. As used herein, “control” a pest or “controlling” pest(s) refers to killing, incapacitating, repelling, or otherwise decreasing the negative impact of the pest on plants or animals to a level that is desirable to the grower or animal.

As used herein, “pest's environment” refers to any area that the pest is present during any life stage. One environment likely to be treated by the methods of the present invention includes the plants that the pest is living on and the surrounding soil. The pest's environment may also include harvested plants, gardens, fields, greenhouses, or other buildings, and various indoor surfaces and structures, such as furniture including beds, and furnishings including books, clothing, etc.

The articles “a,” “an” and “the” are intended to include the plural as well as the singular, unless the context clearly indicates otherwise. For example, the methods of the present invention are directed to controlling “pest”, but this can include control of a multiple pests (such as a more than one insect or more than one insect species or more than one mite or more than one mite species).

What is claimed is:

1. A pesticidal mixture comprising an effective amount of sabadilla alkaloids and at least one pesticide selected from the group consisting of acetylcholinesterase (“AChE”) inhibitors including but not limited to carbamates such as alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, xmc, xylylcarb and organophosphates such as acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-s-methyl, diazinon, dichlorvos/ddvp, dicrotophos, dimethoate, dimethylvinphos, disulfoton, epn, ethion, ethoprophos, famphur, fenamiphos, fenitrothion, fenthion, fosthiazate, heptenophos, isofenphos, isoxathion, malathion, mecarbam, methamidophos, methidathion, mevinphos, monocrotophos, naled, omethoate, oxydemeton-methyl, parathion, parathion-methyl, phenthoate, phosalone, phorate, phosmet, phosphamidon, phoxim, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion, pirimiphos-methyl, imicyafos, isopropyl o-(methoxyaminothio-phosphoryl) salicylate; gamma-amino butyric acid (“GABA”)-gated chloride channel blockers including but not limited to cyclodiene organochlorines such as chlordane and endosulfan; sodium channel modulators including, but not limited to, dichlorodiphenyltrichloroethane (“DDT”) and methoxychlor; nicotinic acetylcholine receptor (“nAChR”) competitive modulators including, but not limited to, butenolides such as flupyradifurone, zwitterionics such as dicloromezotiaz and triflumezopyrim, sulfoximines such as sulfoxaflor and nicotine; alkylhalides such as methyl bromide; fluorides such as cryolite and sulfuryl fluoride; borates such as borax, boric acid, disodium octaborate, sodium borate and sodium metaborate; methyl isothiocyanate generators such as dazomet and metam; chloropicrin; tartar emetic; chordotonal organ transient receptor potential (“TRP”) channel modulators including, but not limited to, pyridine azomethine derivatives such as pymetrozine; inhibitors of mitochondrial adenosine triphosphate (“ATP”) synthase including, but not limited to, organotin miticides such as azocyclotin, cyhexatin and fenbutatin oxide and diafenthiruon, propargite and tetradifon; uncouplers of oxidative phosphorylation via disruption of the proton gradient such as chlorfenapyr, dinitro-ortho-cresol (“DNOC”) and sulfuramide; nAChR channel blockers including, but not limited to, nereistoxin analogues such as bensultap, cartap hydrochloride, thiocyclam and thiosultap-sodium; octopamine receptor agonists such as amitraz; mitochondrial complex III electron transport inhibitors (“METI III”) such as acequinocyl, bifenazate and fluacrypyrim, hydramethylnon; mitochondrial complex I electron transport inhibitors (“METI I”) such as fenazaquin, pyrimidifen, pyridaben, tebufenpyrad and rotenone; voltage-dependent sodium channel blockers including, but not limited to, oxadiazines such as indoxacarb and semicarbazones such as metaflumizone; inhibitors of acetyl coenzyme (“CoA”) carboxylase including, but not limited to, tetronic and tetramic acid derivatives such as spirodiclofen, spiromesifen and spirotetramat,; mitochondrial complex IV electron transport inhibitors (“METI IV”) including, but not limited to, phosphides such as aluminum phosphide, calcium phosphide, phosphine and zinc phosphide and cyanides such as calcium cyanide, potassium cyanide, sodium cyanide; mitochondrial complex II electron transport inhibitors (“METI II) including, but not limited to, beta-ketonitrile derivatives such as cyenopyrafen and cyflumetofen and carboxanilides such as pyflubumide; isoxazolines such as afoxolaner, fluralaner, lotilaner and sarolaner; pyropenes such as afidopyropen; other compounds of an unclassified nature such as benzoximate; bromoproylate; chinomethionat; dicofol; GS-omega/kappa HXTX-HV1A peptide; lime sulfur; sulfur; acynonapyr; flometoquin; and spiroindoline.

2. The mixture of claim 1, wherein the sabadilla alkaloids are derived from Schoenocaulon officinale.

3. The mixture of claim 1, wherein the sabadilla alkaloids are veratridine and cevadine.

4. The mixture of claim 1, further comprising one or more excipients selected from the group consisting of solvents, anti-caking agents, stabilizers, defoamers, slip agents, humectants, dispersants, wetting agents, thickening agents, emulsifiers, penetrants, adjuvants, synergists, polymers, propellants and/or preservatives.

5. A method of controlling a pest comprising applying a pesticidal mixture comprising an effective amount of sabadilla alkaloids and at least one pesticide selected from the group consisting of acetylcholinesterase (“AChE”) inhibitors including but not limited to carbamates such as alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, xmc, xylylcarb and organophosphates such as acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-s-methyl, diazinon, dichlorvos/ddvp, dicrotophos, dimethoate, dimethylvinphos, disulfoton, epn, ethion, ethoprophos, famphur, fenamiphos, fenitrothion, fenthion, fosthiazate, heptenophos, isofenphos, isoxathion, malathion, mecarbam, methamidophos, methidathion, mevinphos, monocrotophos, naled, omethoate, oxydemeton-methyl, parathion, parathion-methyl, phenthoate, phosalone, phorate, phosmet, phosphamidon, phoxim, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion, pirimiphos-methyl, imicyafos, isopropyl o-(methoxyaminothio-phosphoryl) salicylate; gamma-amino butyric acid (“GABA”)-gated chloride channel blockers including but not limited to cyclodiene organochlorines such as chlordane and endosulfan; sodium channel modulators including, but not limited to, dichlorodiphenyltrichloroethane (“DDT”) and methoxychlor; nicotinic acetylcholine receptor (“nAChR”) competitive modulators including, but not limited to, butenolides such as flupyradifurone, zwitterionics such as dicloromezotiaz and triflumezopyrim, sulfoximines such as sulfoxaflor and nicotine; alkylhalides such as methyl bromide; fluorides such as cryolite and sulfuryl fluoride; borates such as borax, boric acid, disodium octaborate, sodium borate and sodium metaborate; methyl isothiocyanate generators such as dazomet and metam; chloropicrin; tartar emetic; chordotonal organ transient receptor potential (“TRP”) channel modulators including, but not limited to, pyridine azomethine derivatives such as pymetrozine; inhibitors of mitochondrial adenosine triphosphate (“ATP”) synthase including, but not limited to, organotin miticides such as azocyclotin, cyhexatin and fenbutatin oxide and diafenthiruon, propargite and tetradifon; uncouplers of oxidative phosphorylation via disruption of the proton gradient such as chlorfenapyr, dinitro-ortho-cresol (“DNOC”) and sulfuramide; nAChR channel blockers including, but not limited to, nereistoxin analogues such as bensultap, cartap hydrochloride, thiocyclam and thiosultap-sodium; octopamine receptor agonists such as amitraz; mitochondrial complex III electron transport inhibitors (“METI III”) such as acequinocyl, bifenazate and fluacrypyrim, hydramethylnon; mitochondrial complex I electron transport inhibitors (“METI I”) such as fenazaquin, pyrimidifen, pyridaben, tebufenpyrad and rotenone; voltage-dependent sodium channel blockers including, but not limited to, oxadiazines such as indoxacarb and semicarbazones such as metaflumizone; Inhibitors of acetyl coenzyme (“CoA”) carboxylase including, but not limited to, tetronic and tetramic acid derivatives such as spirodiclofen, spiromesifen and spirotetramat; mitochondrial complex IV electron transport inhibitors (“METI IV”) including, but not limited to, phosphides such as aluminum phosphide, calcium phosphide, phosphine and zinc phosphide and cyanides such as calcium cyanide, potassium cyanide, sodium cyanide; mitochondrial complex II electron transport inhibitors (“METI II”) including, but not limited to, beta-ketonitrile derivatives such as cyenopyrafen and cyflumetofen and carboxanilides such as pyflubumide; isoxazolines such as afoxolaner, fluralaner, lotilaner and sarolaner; pyropenes such as afidopyropen; other compounds of an unclassified nature such as benzoximate; bromoproylate; chinomethionat; dicofol; GS-omega/kappa HXTX-HV1A peptide; lime sulfur; sulfur; acynonapyr; flometoquin; and spiroindoline to the pest or the pest's environment.

6. The method of claim 5, wherein the pest is at least one of an insect, a mite, a nematode and fungus.
